(19) United States
(12) Patent Application Publication
(10) Pub. No.: US 2008/0036439 A1
(43) Pub. Date: Feb. 14, 2008

(54) APPARATUS TO PREVENT OVERHEATING OF A PRINT HEAD, AND A METHOD THEREOF

(75) Inventors: Nam-kyun KIM, Seongnam-si (KR); Eun-sang Cho, Osan-si (KR); Eun-bong Han, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/620,232

(22) Filed: Jan. 5, 2007

(30) Foreign Application Priority Data
Aug. 8, 2006 (KR) 2006-74660
Oct. 11, 2006 (KR) 2006-98872

(51) Int. Cl. G05F 1/00

(52) U.S. Cl. 323/293

(57) ABSTRACT

An apparatus to prevent overheating of a print head. The apparatus includes a temperature sensing unit, a voltage dividing unit, and a comparing unit. The temperature sensing unit includes a first resistor having a low temperature coefficient of resistance (TCR) and a second resistor having a higher TCR than the first resistor, and outputs a voltage between the first resistor and the second resistor. The first resistor and the second resistor are connected in series. The voltage dividing unit divides a reference voltage and outputs the divided reference voltage. The comparing unit compares the output voltage of the temperature sensing unit and the output voltage of the voltage dividing unit and outputs a signal to stop an operation of the print head according to the comparison result.

### CROSS-REFERENCE TO RELATED APPLICATIONS

This application claims priority under 35 U.S.C. §119(a) from Korean Patent Application No. 10-2006-0074660, filed on Aug. 8, 2006 and Korean Patent Application No. 10-2006-0098872, filed on Oct. 11, 2006, in the Korean Intellectual Property Office, the disclosure of which is incorporated herein in their entireties by reference.

### BACKGROUND OF THE INVENTION

1. Field of the Invention

The present general inventive concept relates to an image forming apparatus, and more particularly, to an apparatus to prevent overheating of a print head to prevent damage to a device due to the overheating of the print head, and a method thereof.

2. Description of the Related Art

A conventional thermal shutdown circuit includes a biasing circuit, a sensing circuit for sensing changes in temperature, a comparing circuit for comparing a voltage difference caused by the changes in temperature and performing a thermal shutdown function, and a hysteresis circuit for generating a hysteresis voltage for the comparing circuit. The thermal shutdown function is implemented by sensing temperature using different temperature coefficient (TC) characteristics of a bipolar transistor and a resistor. The thermal shutdown circuit is designed to obtain a constant reference voltage irrespective of temperature, using the negative TC of the bipolar transistor and the positive TC of the resistor. The reference voltage is applied to a terminal of the comparing circuit. A variable voltage is applied to another terminal of the comparing circuit according to the temperature change characteristics of the resistor, and the reference voltage and the variable voltage are compared. The comparing circuit performs the thermal shutdown function according to the comparison result. The hysteresis circuit is inserted between the biasing circuit and the comparing circuit to prevent malfunction of the comparing circuit caused by noise.

However, when an operational amplifier (OP-AMP) is used in the conventional thermal shutdown circuit, the number of transistors increases, increasing power consumption and chip area. When the sensing circuit is implemented with a bipolar transistor, the processing costs also increase due to the addition of a mask. Moreover, several devices (bipolar transistors, field effect transistors (FETs), resistors, etc.) are used in a single chip, increasing the manufacturing cost.

According to prior art, when an image forming apparatus is in an operating state, i.e., in the course of forming an image, a thermal shutdown circuit operates to prevent overheating and consumes power that is greater than a predetermined value for the operation. However, even when the image forming apparatus is in a standby state due to initial power supply or in an idle state after completion of the image forming operation, the thermal shutdown circuit consumes power that is equal to that consumed in the operating state. In other words, according to the prior art, for example, a current of about 2.14 mA is consumed by the thermal shutdown circuit and a power consumption resulting therefrom reaches about 7.062 mW. The 2.14 mA current corresponds to the amount of current consumed when the image forming apparatus is in the operating state. However, even when the image forming apparatus is in a standby state or an idle state, a current of about 2 mA is supplied to the thermal shutdown circuit. Therefore, according to the prior art, unnecessary current consumption is caused by the thermal shutdown circuit that is in a non-operating state.

### SUMMARY OF THE INVENTION

The present general inventive concept provides an apparatus to prevent overheating of a print head to prevent damage to a device due to the overheating of the print head.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an apparatus to prevent overheating of a print head including a temperature sensing unit, a voltage dividing unit, and a comparing unit. The temperature sensing unit may include a first resistor having a low temperature coefficient of resistance (TCR) and a second resistor having a higher TCR than the first resistor, and may output a voltage between the first resistor and the second resistor. The first resistor and the second resistor are connected in series. The voltage dividing unit divides a reference voltage and outputs the divided reference voltage. The comparing unit compares the output voltage of the temperature sensing unit and the output voltage of the voltage dividing unit and outputs a signal to stop an operation of the print head according to the comparison result.

The resistances of the first resistor and the second resistor may increase as temperature increases.

The voltage dividing unit may include a third resistor and a fourth resistor having low TCRs, connected in series, and output a voltage between the third resistor and the fourth resistor to the comparing unit.

The resistances of the third resistor and the fourth resistor may increase as temperature increases.

The apparatus may further include a hysteresis unit that compensates for a noise margin.

The hysteresis unit may include a metal-oxide-semiconductor field effect transistor (MOSFET) whose source and drain are connected in parallel with a fifth resistor and whose gate is connected to an output terminal of the comparing unit, and the hysteresis unit may be connected in series with the voltage dividing unit.

The resistance of the fifth resistor may increase as temperature increases.

The hysteresis unit may operate when the comparing unit outputs the signal to stop an operation of the print head.

The apparatus may be included in an image forming apparatus having a wide array head as the print head.

The foregoing and/or other aspects and utilities of the present general inventive concept may also be achieved by providing an apparatus to prevent overheating of a print head, including a control unit, a bias voltage supply unit, a field effect transistor (FET), a temperature sensing unit, a voltage dividing unit, and a comparing unit. The control unit checks an operation state of an image forming apparatus and outputs a check result. The bias voltage supply unit supplies a bias voltage according to the check result. The FET is connected to the bias voltage supply unit. The temperature sensing unit includes a first resistor having a low temperature coefficient of resistance (TCR) and a second resistor having a higher TCR than the first resistor, connected in series, and outputs a voltage between the first resistor and the second resistor according to the bias voltage. The voltage dividing unit divides a bias voltage and outputs the divided bias voltage. The comparing unit compares the output voltage of the temperature sensing unit and the output voltage of the voltage dividing unit and outputs a signal to stop an operation of the print head according to the comparison result.

The apparatus may further include a driving signal output unit that outputs a signal to stop an operation of the print head according to the check result of the control unit and the comparison result of the comparing unit.

The driving signal output unit may include a first inverter, a NAND gate, and a second inverter. The first inverter inverts a low signal or a high signal corresponding to the check result of the control unit. The NAND gate performs a NAND operation on the comparison result of the comparing unit and the output of the first inverter The second inverter inverts a low signal or a high signal corresponding to the operation result of the NAND gate.

The apparatus may further include a hysteresis unit that compensates for a noise margin.

The apparatus may be included in an image forming apparatus having a wide array head as the print head.

The foregoing and/or other aspects and utilities of the present general inventive concept may also be achieved by providing an apparatus to prevent overheating of a print head, the apparatus including a temperature sensing unit to output a voltage corresponding to a temperature of the print head, a voltage dividing unit to divide a voltage corresponding to an operation state of the apparatus and to output the divided reference voltage, and a comparing unit to compare the output voltage of the temperature sensing unit and the output voltage of the voltage dividing unit and to output a signal to stop an operation of the print head according to the comparison result.

The signal output from the comparing unit may be low if the output voltage of the temperature sensing unit is less than or equal to the output voltage of the voltage dividing unit.

The signal output from the comparing unit may be high if the output voltage of the temperature sensing unit is greater than the output voltage of the voltage dividing unit.

The foregoing and/or other aspects and utilities of the present general inventive concept may also be achieved by providing a method of preventing overheating of a print head, the method including outputting a voltage between a first resistor and a second resistor, dividing a reference voltage and outputting the divided reference voltage, and comparing the output voltage and the divided reference voltage and outputting a signal to stop an operation of the print head according to the comparison result.

The foregoing and/or other aspects and utilities of the present general inventive concept may also be achieved by providing a method of preventing overheating of a print head, the method including checking an operation state of an image forming apparatus and outputting a check result, supplying a bias voltage according to the check result, outputting a voltage between a first resistor and a second resistor according to the bias voltage, dividing the bias voltage and outputting the divided bias voltage, and comparing the output voltage and the output divided bias voltage and outputting a signal to stop an operation of the print head according to the comparison result.

The foregoing and/or other aspects and utilities of the present general inventive concept may also be achieved by providing a method of preventing overheating of a print head, the method including outputting a voltage corresponding to a temperature of the print head, dividing a voltage corresponding to an operation state of the apparatus and outputting the divided reference voltage, and outputting a signal corresponding to a comparison of the output voltage of the temperature sensing unit and the output voltage of the voltage dividing unit, and stopping an operation of the print head according to the signal.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a circuit diagram of an apparatus to prevent overheating of a print head according to an embodiment of the present general inventive concept;

FIG. 2 is a waveform diagram illustrating the apparatus to prevent overheating of a print head illustrated in FIG. 1;

FIG. 3 is a circuit diagram of an apparatus to prevent overheating of a print head according to another embodiment of the present general inventive concept; and

FIG. 4 is a waveform diagram illustrating an amount of current consumption according to an operation state of an image forming apparatus.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

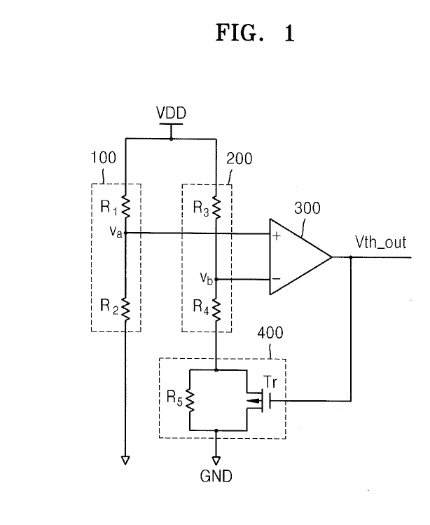

FIG. 1 is a circuit diagram of an apparatus to prevent overheating of a print head according to an embodiment of the present general inventive concept. The apparatus includes a temperature sensing unit 100, a voltage dividing unit 200, a comparing unit 300, and a hysteresis unit 400.

The temperature sensing unit 100 includes a first resistor R1 that has a low temperature coefficient of resistance (TCR) and a second resistor R2 that has a higher TCR than the first resistor R1, connected in series. The temperature sensing unit 100 outputs a voltage Va between the first resistor R1 and the second resistor R2 to a terminal of the comparing unit 300. The TCR expresses the temperature coefficient of a resistance in units of ppm/K. A low TCR denotes a small change in resistance according to a change in temperature. In contrast, a high TCR denotes a large change in resistance according to a change in temperature. The resistances of the first resistor R1 and the second resistor R2 of the temperature sensing unit 100 may increase with a corresponding increase in temperature.

The voltage Va between the first resistor R1 and the second resistor R2 changes according to changes in the resistances of the first resistor R1 and the second resistor R2, and is output to the comparing unit 300.

The voltage dividing unit 200 divides a reference voltage VDD and outputs the divided voltage to the comparing unit 300. The voltage dividing unit 200 includes a third resistor R3 and a fourth resistor R4 both having a low TCR, connected in series. The voltage dividing unit 200 outputs a voltage Vb between the third resistor R3 and the fourth resistor R4 to the comparing unit 300.

The resistances of the third resistor R3 and the fourth resistor R4 may increase as temperature increases.

The comparing unit 300 compares the output voltage Va of the temperature sensing unit 100 and the output voltage Vb of the voltage dividing unit 200 and outputs a signal Vth_out to stop an operation of a print head according to the comparison result. Accordingly, the comparing unit 300 outputs a low signal when the output voltage Va of the temperature sensing unit 100 is less than the output voltage Vb of the voltage dividing unit 200, and outputs a high signal when the output voltage Va of the temperature sensing unit 100 is greater than the output voltage Vb of the voltage dividing unit 200. The low signal indicates that the print head is at a normal temperature, and the high signal indicates that the print head is overheated.

For example, it is assumed that the first resistor R1, the third resistor R3, and the fourth resistor R4 have a TCR of about 377 ppm/K and the second resistor R2 has a TCR of about 1490 ppm/K. At room temperature (e.g. 27° C.), the resistance per unit area Rsh of the first resistor R1, the third resistor R3, and the fourth resistor R4 can be obtained as follows.

Rsh=6.53×(1+3.77×e⁻⁴×(T-27)+3.12×e⁻⁶×(T-27)2) [Equation 1]

Equation 1 illustrates that the resistance per unit area of the first resistor R1, the third resistor R3, and the fourth resistor R4 is about 6.53Ω.

The resistance per unit area Rsh of the second resistor R2 can be obtained as follows.

Rsh=78.68×(1+1.49×e⁻³×(T-27)+1.05×e⁻⁶×(T-27)²) [Equation 2]

Equation 2 illustrates that the resistance per unit area of the second resistor R2 is about 78.68Ω.

If the reference voltage VDD is 3.3 V, the output voltage Va of the temperature sensing unit 100 is 1.65 V and the output voltage Vb of the voltage dividing unit 200 is 1.713 V, at room temperature. Thus, since the output voltage Va of the temperature sensing unit 100 is less than the output voltage Vb of the voltage dividing unit 200, the comparing unit 300 outputs the low signal. However, if the print head is overheated to 120° C., the resistance per unit area of the first resistor R1, the third resistor R3, and the fourth resistor R4 changes to about 6.93Ω and the resistance per unit area of the second resistor R2 changes to 90.3Ω. As a result, the output voltage Va of the temperature sensing unit 100 becomes 1.714 V and the output voltage Vb of the voltage dividing unit 200 stays at 1.713 V. Since the output voltage Va of the temperature sensing unit 100 is greater than the output voltage Vb of the voltage dividing unit 200, the comparing unit 300 outputs the high signal, which corresponds to a reset signal to stop the operation of the print head. Thus, the operation of the print head is stopped and the print head can cool.

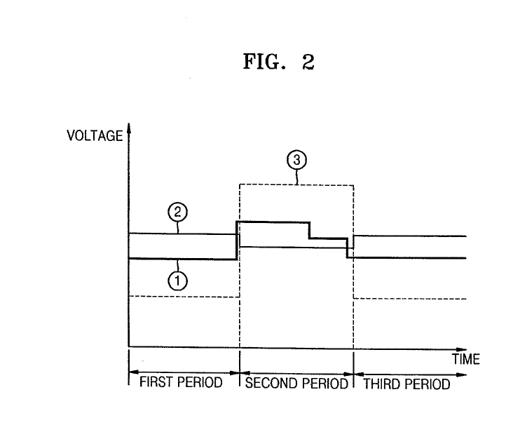

FIG. 2 is a waveform diagram illustrating the apparatus to prevent overheating of a print head illustrated in FIG. 1. Referring to FIGS. 1 and 2, (1) indicates the output voltage Va of the temperature sensing unit 100, (2) indicates the output voltage Vb of the voltage dividing unit 200, and (3) indicates the output signal Vth_out of the comparing unit 300. During a first period and a third period, the output voltage Va of the temperature sensing unit 100 is less than the output voltage Vb of the voltage dividing unit 200, and thus the comparing unit 300 outputs the low signal as the output signal Vth_out. However, during a second period, the output voltage Va of the temperature sensing unit 100 is greater than the output voltage Vb of the voltage dividing unit 200, and thus the comparing unit 300 outputs the high signal as the output signal Vth_out.

The hysteresis unit 400 compensates for a noise margin. In the hysteresis unit 400, a source and a drain of a metal-oxide-semiconductor field effect transistor (MOSFET) Tr are connected in parallel with a fifth resistor R5 and a gate of the MOSFET Tr is connected to an output terminal of the comparing unit 300. The hysteresis unit 400 is connected in series with the voltage dividing unit 200. The resistance of the fifth resistor R5 may increase as temperature increases. The MOSFET Tr is an n-MOSFET. The hysteresis unit 400 may operate when the comparing unit 300 outputs the signal to stop the operation of the print head, i.e., the high signal.

When the comparing unit 300 outputs the high signal, the MOSFET Tr is turned on and the output voltage Vb of the voltage dividing unit 200 decreases from 1.713 V to about 1.683 V. After the operation of the print head is stopped, the temperature of the print head gradually decreases. When the temperature of the print head reaches a normal operation temperature of 60° C., the output voltage Vb of the voltage dividing unit 200 refers to at 1.713 V and the comparing unit 300 outputs the low signal. Since a comparison voltage difference of the comparing unit 300 is only 1 mV, a hysteresis voltage of 30 mV should be maintained to prevent malfunction of the comparing unit 300 due to noise. Accordingly, a voltage of 1.713 V through 1.683 V corresponds to a hysteresis zone to secure a noise margin.

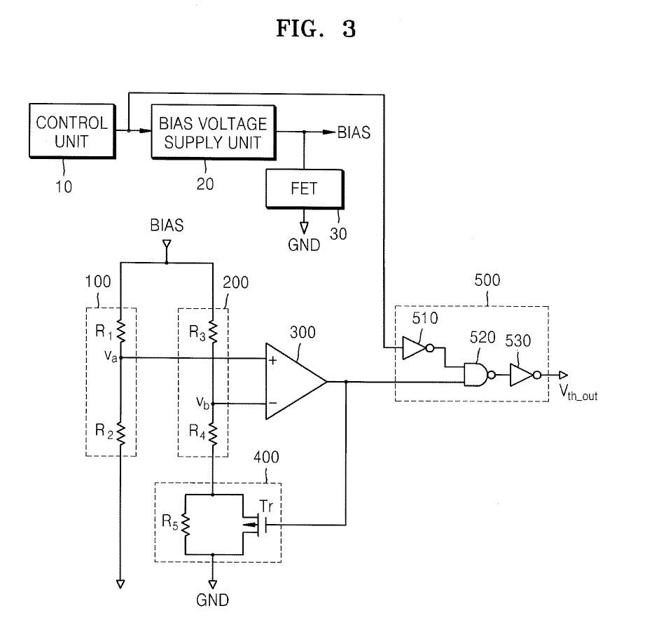

FIG. 3 is a circuit diagram of an apparatus to prevent overheating of a print head according to another embodiment of the present general inventive concept. The apparatus includes a control unit 10, a bias voltage supply unit 20, a field effect transistor (FET) 30, a temperature sensing unit 100, a voltage dividing unit 200, a comparing unit 300, a hysteresis unit 400, and a driving signal output unit 500.

The control unit 10 checks an operation state of an image forming apparatus and outputs a check result to the bias voltage supply unit 20. The control unit 10 checks if the image forming apparatus is in an operating state to form an image or in a standby state or an idle state in which the image forming operation is stopped. The operation state may be checked by checking if a driving engine to form an image is in the operating state. The control unit 10 outputs the check result as a low signal or a high signal. For example, the control unit 10 may output a high signal when the image forming apparatus is in the standby state or the idle state and output a low signal when the image forming apparatus is in the operating state.

The bias voltage supply unit 20 supplies a bias voltage BIAS to the voltage dividing unit 200 according to the check result. For example, the bias voltage supply unit 20 outputs a low signal corresponding to a bias voltage of 0 v to the voltage dividing unit 200 if the high signal corresponding to the standby state or the idle state is output from the control unit 10 and outputs a high signal corresponding to a bias voltage of 3.3 v to the voltage dividing unit 200 if the low signal corresponding to the operating state is output from the control unit 10. The bias voltage supply unit 20 includes a conventional general bias circuit, and thus will not described in detail.

To detect the bias voltage BIAS output from the bias voltage supply unit 20, the FET 30 is connected to the bias voltage supply unit 20. The FET 30 may be an n-type metal-oxide-semiconductor FET (n-MOSFET).

The temperature sensing unit 100 includes a first resistor R1 that has a low temperature coefficient of resistance (TCR) and a second resistor R2 that has a higher TCR than the first resistor R1, connected in series. The temperature sensing unit 100 outputs a voltage Va between the first resistor R1 and the second resistor R2 according to the bias voltage BIAS supplied from the bias voltage supply unit 20 to both terminals of the comparing unit 300. The function of the temperature sensing unit 100 of FIG. 3 is the same as that of the temperature sensing unit 100 of FIG. 1, and thus will not described in detail.

The voltage dividing unit 200 divides the bias voltage BIAS supplied from the bias voltage supply unit 20 and outputs the divided voltage to the comparing unit 300. The voltage dividing unit 200 includes a third resistor R3 and a fourth resistor R4 which both have a low TCR, connected in series. The voltage dividing unit 200 outputs a voltage Vb between the third resistor R3 and the fourth resistor R4 to the comparing unit 300. The resistances of the third resistor R3 and the fourth resistor R4 may increase as temperature increases.

The comparing unit 300 compares the output voltage Va of the temperature sensing unit 100 and the output voltage Vb of the voltage dividing unit 200, and outputs a signal Vth_out to stop an operation of a print head according to the comparison result.

If the low signal corresponding to the bias voltage of 0 v is output from the bias voltage supply unit 20, the comparing unit 300 enters a disabled state. At this time, the apparatus to prevent overheating of a print head is not actuated and thus power consumption can be minimized.

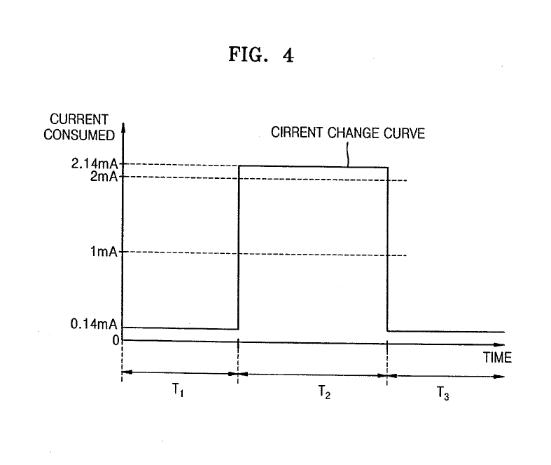

FIG. 4 is a waveform diagram illustrating an amount of current consumption according to an operation state of an image forming apparatus. Referring to FIG. 4, a current of 2.14 mA is consumed in an operating state T2, but a current of 0.14 mA is consumed in a standby state T1 or an idle state T3 because the apparatus to prevent overheating of a print head is not actuated. Accordingly, a power of only about 0.462 mW is consumed in the standby state or the idle state, thereby reducing power consumption by 93% when compared to the prior art.

If the high signal corresponding to the bias voltage of 3.3 v is output from the bias voltage supply unit 20, the comparing unit 300 outputs a signal that varies according to the output voltage Va of the temperature sensing unit 100 and the output voltage Vb of the voltage dividing unit 200. Accordingly, the comparing unit 300 outputs a low signal when the output voltage Va of the temperature sensing unit 100 is less than or equal to the output voltage Vb of the voltage dividing unit 200, and outputs a high signal when the output voltage Va of the temperature sensing unit 100 is greater than the output voltage Vb of the voltage dividing unit 200. The low signal indicates that the print head is at a normal temperature, and the high signal indicates that the print head is overheated.

The hysteresis unit 400 compensates for a noise margin. In the hysteresis unit 400, a source and a drain of a MOSFET Tr are connected in parallel with a fifth resistor R5 and a gate of the MOSFET Tr is connected to an output terminal of the comparing unit 300. The hysteresis unit 400 is connected in series with the voltage dividing unit 200. The resistance of the fifth resistor R5 may increase as temperature increases. The MOSFET Tr is an n-MOSFET. The hysteresis unit 400 may operate when the comparing unit 300 outputs the signal to stop the operation of the print head, i.e. the high signal.

The driving signal output unit 500 outputs a signal Vth_out to stop an operation of a print head according to the comparison result of the comparing unit 300. The driving signal output unit 500 is required to prevent an inaccurate output operation of the comparing unit 300 due to an abnormal operation of the apparatus to prevent overheating of a print head. Accordingly, the driving signal output unit 500 includes a first inverter 510, a NAND gate 520, and a second inverter 530 as illustrated in FIG. 3.

The first inverter 510 inverts a low signal or a high signal corresponding to the check result of the control unit 10 and outputs the inversion result to the NAND gate 520. For example, the first inverter 510 outputs the high signal when the check result of the control unit 10 corresponds to the low signal, and outputs the low signal when the check result of the control unit 10 corresponds to the high signal.

The NAND gate 520 performs a NAND operation on the comparison result of the comparing unit 300 and the output of the first inverter 510 and outputs the operation result to the second inverter 530. For example, when the output signal of the first inverter 510 is the low signal (i.e., the output signal of the control unit 10 is the high signal) and the comparison result of the comparing unit 300 is the low signal, the NAND gate 520 outputs the high signal. When the output signal of the first inverter 510 is the high signal (i.e., the output signal of the control unit 10 is the low signal) and the comparison result of the comparing unit 300 is the high signal, the NAND gate 520 outputs the low signal.

The second inverter 530 inverts the low signal or the high signal corresponding to the output of the NAND gate 520. For example, when the output signal of the NAND gate 520 is the low signal, the second inverter 530 outputs the high signal as the output signal Vth_out. When the output signal of the NAND gate 520 is the high signal, the second inverter 530 outputs the low signal as the output signal Vth_out. The low signal output from the second inverter 530 indicates that the image forming apparatus is in a normal operating state or a standby state. The high signal output from the second inverter 530 is a reset signal to stop the operation of the print head. Thus, the operation of the print head is stopped and the print head can cool.

The apparatus to prevent overheating of the print head may be included in an image forming apparatus having a wide array head, which contains a plurality of array heads and generates much heat during printing.

According to the present general inventive concept, the apparatus to prevent overheating of the print head includes a thermal shutdown circuit which occupies a small area and has an optimal performance and a minimum processing cost. Therefore, overheating of the print head can be prevented without a complex structure and various chips, contributing to low cost and high efficiency. Moreover, the apparatus to prevent overhead of the print head according to the present general inventive concept can minimize power consumption caused in a state in which the image forming apparatus does not operate.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to prevent overheating of a print head, the apparatus comprising:
a temperature sensing unit including a first resistor having a low temperature coefficient of resistance (TCR) connected in series with a second resistor having a higher TCR than the first resistor, to output a voltage between the first resistor and the second resistor;
a voltage dividing unit to divide a reference voltage and to output the divided reference voltage; and
a comparing unit to compare the output voltage of the temperature sensing unit and the output voltage of the voltage dividing unit and to output a signal to stop an operation of the print head according to the comparison result.

2. The apparatus of claim 1, wherein the resistances of the first resistor and the second resistor increase as temperature increases.

3. The apparatus of claim 1, wherein the voltage dividing unit includes a third resistor and a fourth resistor having low TCRs, connected in series, and outputs a voltage between the third resistor and the fourth resistor to the comparing unit.

4. The apparatus of claim 3, wherein the resistances of the third resistor and the fourth resistor increase as temperature increases.

5. The apparatus of claim 1, further comprising:
a hysteresis unit to compensate for a noise margin.

6. The apparatus of claim 5, wherein the hysteresis unit includes a metal-oxide-semiconductor field effect transistor (MOSFET) whose source and drain are connected in parallel with a fifth resistor and whose gate is connected to an output terminal of the comparing unit, and the hysteresis unit is connected in series with the voltage dividing unit.

7. The apparatus of claim 6, wherein the resistance of the fifth resistor increases as temperature increases.

8. The apparatus of claim 5, wherein the hysteresis unit operates when the comparing unit outputs the signal to stop the operation of the print head.

9. The apparatus of claim 1, wherein the apparatus is included in an image forming apparatus and has the print head comprising a wide array head.

10. An apparatus to prevent overheating of a print head, the apparatus comprising:
a control unit to check an operation state of an image forming apparatus and to output a check result;
a bias voltage supply unit to supply a bias voltage according to the check result;
a field effect transistor (FET) connected to the bias voltage supply unit;
a temperature sensing unit including a first resistor having a low temperature coefficient of resistance (TCR) connected in series with a second resistor having a higher TCR than the first resistor, and outputting a voltage between the first resistor and the second resistor according to the bias voltage;
a voltage dividing unit to divide the bias voltage and output the divided bias voltage; and
a comparing unit to compare the output voltage of the temperature sensing unit and the output voltage of the voltage dividing unit and to output a signal to stop an operation of the print head according to the comparison result.

11. The apparatus of claim 10, further comprising:
a driving signal output unit to output a signal to stop the operation of the print head according to the check result of the control unit and the comparison result of the comparing unit.

12. The apparatus of claim 11, wherein the driving signal output unit comprises:
a first inverter to invert a low signal or a high signal corresponding to the check result of the control unit;
a NAND gate to perform a NAND operation on the comparison result of the comparing unit and the output of the first inverter; and
a second inverter to invert a low signal or a high signal corresponding to the operation result of the NAND gate.

13. The apparatus of claim 10, further comprising:
a hysteresis unit to compensate for a noise margin.

14. The apparatus of claim 10, wherein the apparatus is included in an image forming apparatus and has the print head comprising a wide array head.

15. An apparatus to prevent overheating of a print head, the apparatus comprising:
a temperature sensing unit to output a voltage corresponding to a temperature of the print head;
a voltage dividing unit to divide a voltage corresponding to an operation state of the apparatus and to output the divided reference voltage; and
a comparing unit to compare the output voltage of the temperature sensing unit and the output voltage of the voltage dividing unit and to output a signal to stop an operation of the print head according to the comparison result.

16. The apparatus of claim 15, wherein the signal output from the comparing unit is low if the output voltage of the temperature sensing unit is less than or equal to the output voltage of the voltage dividing unit.

17. The apparatus of claim 15, wherein the signal output from the comparing unit is high if the output voltage of the temperature sensing unit is greater than the output voltage of the voltage dividing unit.

18. A method of preventing overheating of a print head, the method comprising:
outputting a voltage measured between a first resistor and a second resistor;
dividing a reference voltage and outputting the divided reference voltage; and
comparing the output voltage and the divided reference voltage and outputting a signal to stop an operation of the print head according to the comparison result.

19. A method of preventing overheating of a print head, the method comprising:
checking an operation state of an image forming apparatus and outputting a check result;
supplying a bias voltage according to the check result;
outputting a voltage between a first resistor and a second resistor according to the bias voltage;
dividing the bias voltage and outputting the divided bias voltage; and
comparing the output voltage and the output divided bias voltage and outputting a signal to stop an operation of the print head according to the comparison result.

20. A method of preventing overheating of a print head, the method comprising:
outputting a voltage corresponding to a temperature of the print head;
dividing a voltage corresponding to an operation state of the apparatus and outputting the divided reference voltage;
outputting a signal corresponding to a comparison of the output voltage of the temperature sensing unit and the output voltage of the voltage dividing unit; and
stopping an operation of the print head according to the signal.
